(19) United States
(12) Patent Application Publication
(10) Pub. No.: US 2005/0129212 A1
(43) Pub. Date: Jun. 16, 2005

(54) Workforce planning system incorporating historic call-center related data

(76) Inventor: Jane Smith Parker, Douglasville, GA (US)

Correspondence Address: THOMAS, KAYDEN, HORSTEMEYER & RISLEY, LLP/;BELLSOUTH I.P. CORP, 100 GALLERIA PARKWAY, SUITE 1750, ATLANTA, GA, 30339, US

(21) Appl. No.: 10/735,099

(22) Filed: Dec. 12, 2003

(51) Int. Cl. H04M 3/00; H04M 5/00

(52) U.S. Cl. 379/265.03; 379/266.08

(57) ABSTRACT

Systems and methods for workforce planning, which in one embodiment among many, can be broadly summarized by a representative method of generating a forecast report by processing a work-planning input together with a performance report, the performance report having been generated by processing a call-history statistic obtained from a communication switch and/or a work-history statistic obtained from a call center. Another embodiment can be described as a workforce planning system that has logic configured to generate a forecast report by processing a work-planning input together with a performance report, the performance report having been generated by logic configured to process a call-history statistic obtained from a communication switch and/or a work-history statistic obtained from a call center.

### TECHNICAL FIELD

The present disclosure is generally related to planning and, more particularly, is related to workforce planning.

### BACKGROUND

Various aspects of call center operations are typically directed by an operations group made up of a number of staff personnel who operate a computer system that may be referred to as a workforce management computer system. This computer system is communicatively coupled to a communication switch that provides telecommunication services to one or more call centers. Telephone call statistics related to call center operations are transmitted by the communication switch to the workforce management computer system, where the operations group then performs data gathering, analysis, and prediction with the goal of managing the labor force that operates a call center.

In addition to obtaining call statistics from the communication switch, the data gathering aspect also includes obtaining information from the call center. This information is typically collected by call center staff who carry out attendance tracking and record-keeping related to work operations and times of the various operators in the center. The data may be recorded on paper in certain cases, or alternatively, may be recorded on computers in other cases, before transmission to the staff of the workforce management system.

Workforce planning, which includes predicting the size and composition of the labor force to be employed over a future period of time in the call center, involves processing the data obtained from the communications switch and the call center to generate a planning report. Typically, this processing comprises manual examination of the statistics obtained from the two sources, and providing a best-guess forecast of various parameters, including the desired size and composition of the operators. As is typical of many manual processes, the generation of a planning report in this manner is prone to processing errors. Such errors occur due to various human shortcomings, such as lack of objectivity, data entry errors, and computational errors. Additionally, unlike computers, humans do not typically process large amounts of data, homogenous or otherwise, in an efficient manner. In many cases, the quality of the planning report is largely dependent on the individual qualifications of the processing staff. Consequently, a planning report produced by a first individual will differ in quality to that produced by a second individual, thereby leading to non-uniform product quality across individuals and across time.

It is therefore desirable to provide a workforce planning system that addresses such problems.

### SUMMARY OF THE DISCLOSURE

One embodiment among others, of the present disclosure includes generating a forecast report by processing work-planning input together with a performance report, the performance report having been generated by processing a call-history statistic obtained from a communication switch and/or a work-history statistic obtained from a call center.

Other systems, methods, and/or computer program products according to embodiments will be or become apparent to one skilled in the art upon review of the following drawings and detailed description. It is intended that all such additional systems, methods, and/or computer program products be included within this description and be within the scope of the present disclosure.

### BRIEF DESCRIPTION OF DRAWINGS

Many aspects of the disclosure can be better understood with reference to the following drawings. The components in the drawings are not necessarily to scale, emphasis instead being placed upon clearly illustrating the principles of the present disclosure. Moreover, in drawings, like reference numerals designate corresponding parts throughout the several views.

FIG. 1 is a block diagram of a workforce management system communicatively coupled to a communications switch that provides switching services to one or more workforce centers.

FIG. 2 is a block diagram of a workforce management system comprising a network of computing elements, the management system being communicatively coupled to a communication switch that is a part of the POTS network and/or the Internet.

FIG. 3 is a block diagram illustrating various functional blocks of one embodiment among many, of a computing element of the workforce management system of FIG. 1, where the computing element includes a workforce planning system.

FIG. 4 is a block diagram illustrating various functional blocks of one embodiment among many, of a communication switch processing unit that is located inside the communications switch of FIG. 1, the communication switch processing unit being communicatively coupled to the workforce management system of FIG. 3.

FIG. 5 is a block diagram illustrating various functional blocks of one embodiment among many, of a computer located in a call center, the computer being configured to be a part of a workforce planning system incorporated in the workforce management system of FIG. 3.

FIG. 6 is an exemplary flowchart describing one among many embodiments of a method for implementing the workforce planning system of FIG. 3.

FIG. 7 is one embodiment among many, of a workforce planning report.

### DETAILED DESCRIPTION OF THE PREFERRED EMBODIMENTS

While the description below refers to certain exemplary embodiments, it is to be understood that the disclosure is not limited to these particular embodiments. On the contrary, the intent is to cover all alternatives, modifications and equivalents included within the spirit and scope of the disclosure as defined by the appended claims. Also, the terminology used herein is for the purpose of description and not of limitation.

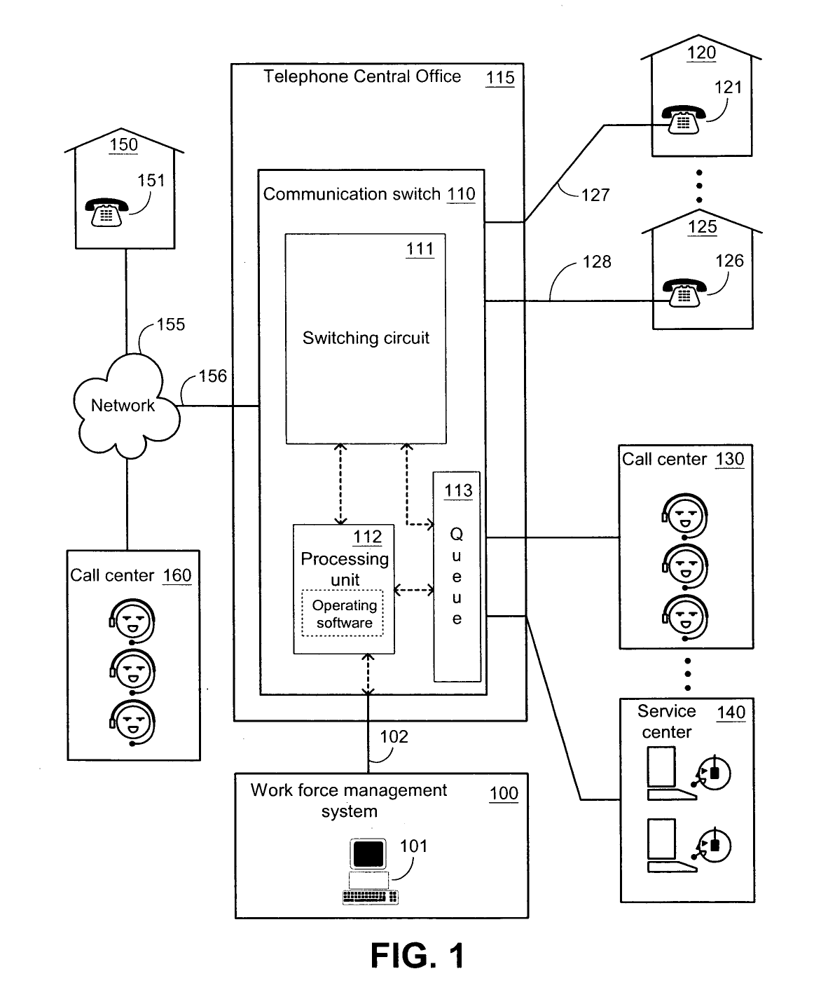

FIG. 1 is a block diagram of a workforce management system 100 communicatively coupled to a communications switch 110, which in this exemplary embodiment, is a plain old telephone service (POTS) switch located in a telephone central office (CO) 115. The POTS switch is connected on its trunk side to network 155, which in this first embodiment is the public switched telephone network (PSTN). The POTS switch provides telephone service to many customers, such as residential customers located in residences 120 and 125 that are connected to the line side of the POTS switch via links 127 and 128 that constitute the telephone local loop. These residences contain telephones 121 and 126 as shown, but may additionally accommodate communication devices such as PCs used by the residential customers for Internet access.

The POTS switch of this embodiment may be further configured to provide telephone services via the PSTN of this embodiment, to an additional residential customer located in residence 150. The residential customer in residence 150 communicates to a customer in residence 120, by obtaining a connection through the PSTN and through the POTS switch. This type of customer who is located outside an local access transport area (LATA) served by the switch, is classified as a long-distance customer, and is sometimes referred to as an inter-LATA customer.

Communication switch 115 is further configured to provide telecommunication services such as routing telephone calls from telephone customers in residences 120, 125, and 150 to telephone operators located in a call center 130. The telephone operators inside call center 130 provide a number of customer services such as directory assistance and operator-assisted call connections.

In a second exemplary embodiment, communication switch 110 comprises a digital subscriber line access multiplexer (DSLAM) to provide Internet access and various data services to residences 120, 125, and 150, and also to business customers located in businesses (not shown) that are connected to the DSLAM either via the local loop or via network 155. The DSLAM of this second exemplary embodiment is typically configured to route data traffic to a server that is located in an Internet service provider (ISP) location. Routing of data traffic is carried out over network 155 that in this exemplary second embodiment, comprises the Internet.

In a third exemplary embodiment, communication switch 110 comprises a device that is referred to in the industry as a softswitch, or alternatively comprises a device that is referred to in the industry as a gateway. The softswitch/gateway of this third exemplary embodiment switches data packets in providing data services to residences 120, 125, and 150, and also to business customers located in businesses (not shown) that are connected to the device either via the local loop or via network 155. Network 155 will comprise the Internet in this third exemplary embodiment.

The softswitch/gateway of this exemplary embodiment is not necessarily confined to providing data services, but can also be configured to provide voice services over a packet network such as the Internet. One example of such a voice service uses voice-over-Internet protocol (VoIP) to carries voice data as IP packets over the network. With reference to this example, residence 150 or a business (not shown) that is connected to the Internet (network 155) is, in various embodiments, an international customer located in a country outside the country in which the communication switch 110 is located. Similarly, a call center 160 that is shown connected into network 155 is, in various embodiments, a call center located in a foreign country. Call center 160 and other service centers that are connected to network 155 at an international location, are, in various embodiments, used to provide services to customers such as the ones in residences 120, 125, and 150.

Drawing further attention to FIG. 1, service center 140 is connected to communications switch 140 to permit service center operators to provide additional services to residential and/or business customers. Such services include functions that are similar to that provided by the call center operators, but also comprise many other types of services that include voice as well as data operations.

As one example among many, such services include manual e-mail responses that do not require telephone conversations. A second example involves responding to customer queries related to product support. A third example involves handling of a business transaction such as an automated credit card payment.

It will be understood that such transactions encompass a wide variety of voice transactions carried out over the PSTN, as well as data transactions carried out over a private and/or a public data network including the PSTN and the Internet. It further includes voice transactions that are carried over data networks, for example, as a Voice-over-IP call.

Work force management system (WFMS) 100 that is shown communicatively coupled to switch 115, includes a workforce computer system 101 that in various embodiments, comprises one machine or several machines. In various embodiments, these machines are PCs, workstations, or other computing platforms, that are used in an individual configuration, or comprise a network of several units. WFMS 100 is typically located either inside CO 115 or in an outside office. Typically, WFMS 100 is located in an outside office, that is in certain instances, a geographically remote office located in a city other than the city in which the CO 115 is located.

WFMS 100 is configured to manage certain operations of centers such as call center 130 and service center 140. Such operations include call-volume analysis, call-volume prediction, and producing work schedules for the call center operators based on the predicted call-volume. Call-volume analysis is carried out by obtaining from the communication switch 110, call-statistics such as total number of calls routed to one or more centers, and types of such calls routed, and also by obtaining from one or more call centers, call-handling-statistics such as calls answered, calls abandoned, and average wait times. Call-statistics are typically obtained via digital data that is transported on link 102 from switch 110 to WFMS 100. In various embodiments, link 102 uses various types of hardware and software. In one example among many, link 102 is a circuit switched link such as a T1 line carrying TDM data. In a second example, link 102 is a packet-switched link carrying data packets using a TCP/IP format.

Once WFMS 100 receives the call-statistics, a call-load history is generated from which future call-loads are predicted. Based on these predictions, the work force in one or more call centers are scheduled in a process that is known in the industry as “tours.” Work scheduling is used to adjust the number of call operators at various instances of time depending upon expected call volume. Furthermore, switching processes in switch 110 that are related to routing of calls to the call centers, as well as providing call-weighting (e.g., by adding wait times) to such calls, can be modified at switch 110 upon request from WFMS 100. Such a request is often carried out via telephone calls between the staff of WFMS 100 and those of CO 110.

WFMS 100 is also configured to handle certain other functions related to call center operators. Some of these functions include payroll, attendance, record keeping, and personnel management tasks such as hiring and firing.

Drawing attention to communication switch 110 of FIG. 1, a few operational blocks that are associated with call center operations are shown inside switch 110. Switching circuit 111 carries out the switching function to switch calls originated by customers such as a residential customer from residence 120. Such a call may relate to directory assistance where the customer is seeking directory information, requiring manual servicing by an operator in call center 130. Switching circuit 111 provides the necessary connections to direct this call, in digital data form, to a queue 113. Queue 113 is typically, a first-in-first-out (FIFO) buffer system that regulates the transfer of this call together with any others that may be occurring during this time, to call center 130 or service center 140. The queueing process also typically incorporates a weighting scheme to decide the order in which these calls are placed into, and consequently routed out of, the queue 113. One example among many of a weighting scheme uses a “wait time” factor that determines how quickly an individual call is processed and transported out of the switch. The call is routed from queue 113 to a call center operator in call center 130 for example. Processing unit 112 is typically, a central processing unit (CPU) comprising hardware and software that is a part of communication switch 110. The software inside processing unit 112 includes operating software that controls switching circuit 111, queue 113 and other circuits inside communication switch 110. Processing unit 112 further includes software for interfacing switch 110 to WFMS 100 via link 102.

It will be understood that similar mechanisms for switching and queuing may be employed to interface switch 110 to call center 160 to provide customer service for customers in residences 120, 125, and 150. It will also be understood that WFMS 100 can be communicatively coupled to communication switch 110 through network 155, thereby allowing WFMS 100 to be remotely located.

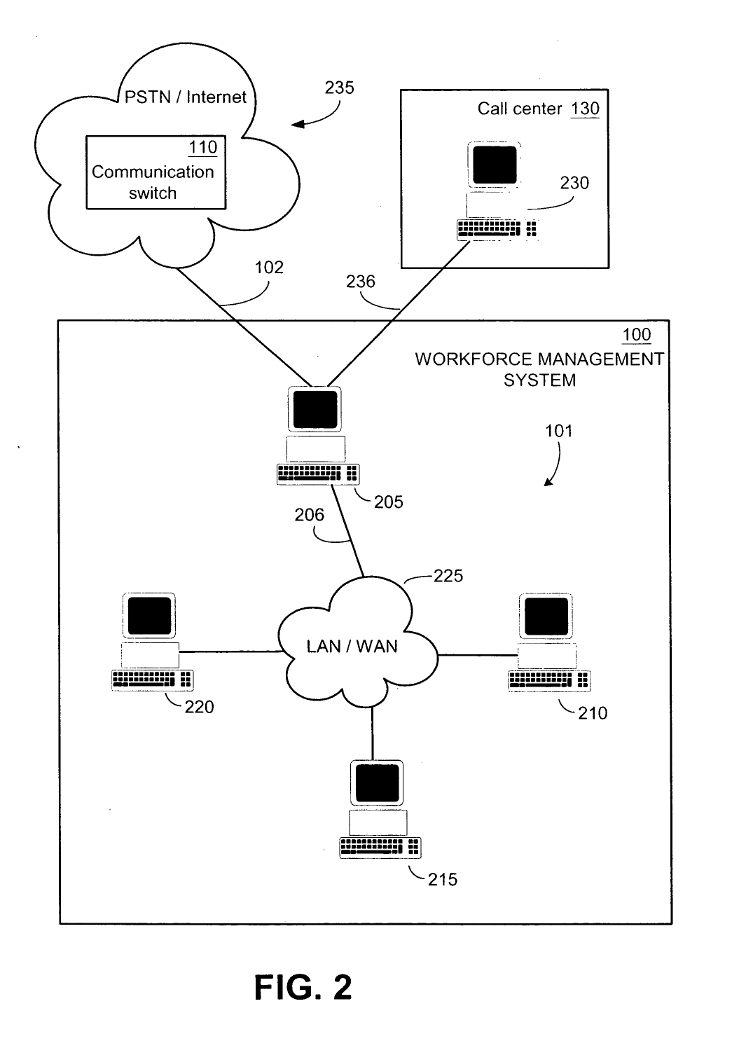

FIG. 2 illustrates one exemplary embodiment among several such embodiments, wherein WFMS 100 comprises workforce computer system 101 configured as a network of computing elements. Computing elements 205, 210, 215, 220, and 230 are five example elements that comprise five PCs, five workstations, five work platforms, and combinations thereof. Element 205 operates in this example as a server/gateway device. While five such elements are shown in FIG. 2 it will be understood that the number of elements in such a network configuration can be any number greater than two. The five elements of FIG. 2 are interconnected to each other by a network 225 that is a local area network (LAN) and/or a wide area network (WAN) comprising a variety of hardware and software elements that incorporate various standards and formats. One example among many, of such a network is an Ethernet LAN transporting data packets using an Ethernet protocol. A second example is a WAN transporting data cells in an ATM format. The five elements shown in this example, are located inside a single building or alternatively, be housed in several buildings that include one or more call centers. They can also be interconnected to each other, to other communication devices, and to communication links in several other appropriate configurations.

In a first exemplary configuration, element 205 operates in a client-server configuration where communication switch 110 that is shown as a part of network 235, operates as a server and element 205 operates as its client. In the context of such a configuration, link 102 is a communication link that transports data packets, and network 235 is a packet network such as the Internet.

In a second exemplary configuration, element 205 operates in a master-slave configuration where communication switch 110 that is shown as a part of network 235, operates as a master device and element 205 its slave. In the context of this second exemplary configuration, link 102 is a communication link that transports circuit switched data, and network 235 is a circuit switched network such as the PSTN.

In some embodiments, element 205 is communicatively coupled to one or more computers that are located in one or more call/service centers, either through communication switch 110 or directly through other communication links as indicated by the dashed line of link 236. The call/service centers are located within a local access transport area (LATA) or alternatively located outside a LATA, including international locations.

FIG. 2 shows one example where a computer 230 in call center 130 is coupled to element 205 through link 236. Link 236 operates in a manner similar to that described for link 102 above. Among other data, administrative information, such as employee work statistics, is electronically communicated by the computer 230 in call center 130 to the computing element 205.

Generally, element 205 provides a number of software application modules that is used locally by the computing elements interconnected via network 225, and/or remotely by the computer 230 in call center 130 as well as computers elsewhere that are communicatively coupled to element 205. While it is not necessary that all these software modules be solely resident in computing element 205, it is generally understood that it is configured in this manner in many system applications.

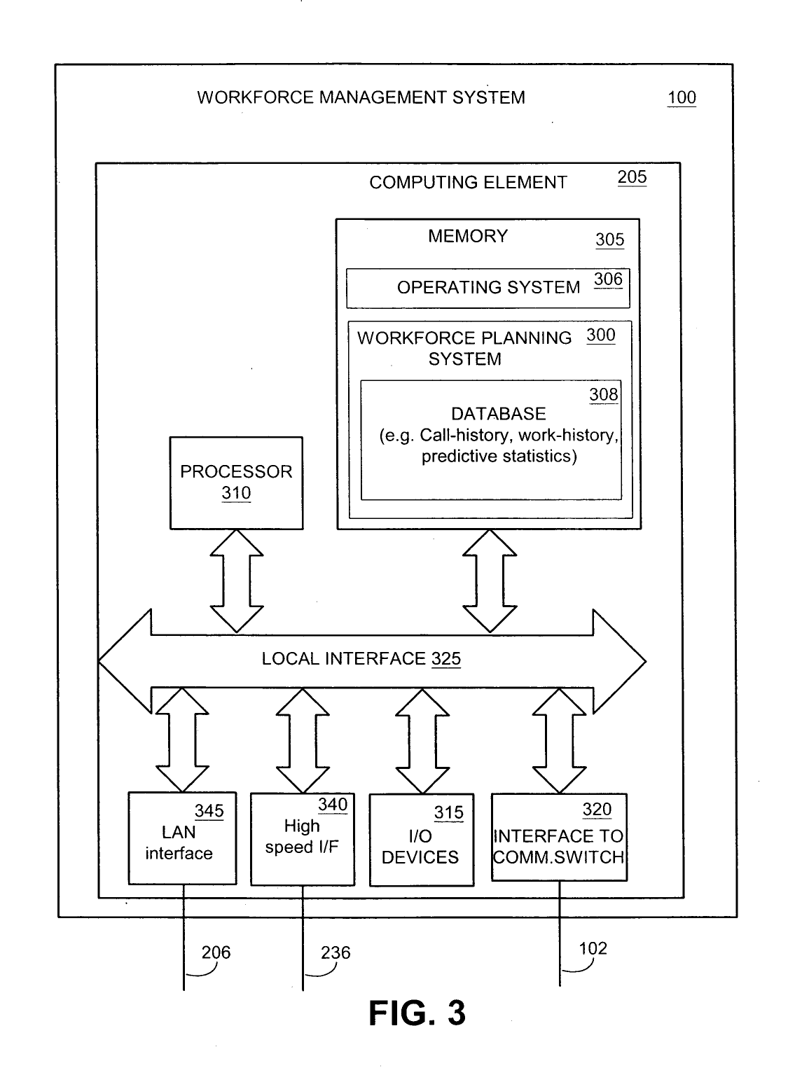

FIG. 3 is a block diagram illustrating various functional blocks incorporated inside element 205 of WFMS 100. Generally, in terms of hardware architecture, as shown in FIG. 3, computing element 205 includes several elements that are communicatively coupled to one another via a local interface 325. Some example elements include, a processor 310, memory 305, a communication switch interface 320, a LAN interface 345, a high-speed interface 340, and one or more input/output (I/O) devices 315 (or peripherals).

The local interface 325 can be, for example but not limited to, one or more buses or other wired or wireless connections, as is known in the art. The local interface 325 can have additional elements, which are omitted for simplicity, such as controllers, buffers (caches), drivers, repeaters, and receivers, to enable communications. Further, the local interface can include address, control, and/or data connections to enable appropriate communications among the aforementioned components.

The processor 310 is a hardware device for executing software, particularly that stored in memory 305. The processor 310 can be any custom made or commercially available processor, a central processing unit (CPU), an auxiliary processor among several processors associated with the computing element 205, a semiconductor based microprocessor (in the form of a microchip or chip set), a macroprocessor, or generally any device for executing software instructions.

The memory 305 includes any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 305 can incorporate electronic, magnetic, optical, and/or other types of storage media. Note that the memory 305 can have a distributed architecture, where various components are situated remote from one another, but can be accessed by the processor 310.

The software in memory 305 includes one or more separate programs, each of which comprises an ordered listing of executable instructions for implementing logical functions. In the example of FIG. 3, the software in the memory 305 includes a workforce planning system 300 that is one among multiple embodiments, and a suitable operating system (O/S) 306. A nonexhaustive list of examples of suitable commercially available operating systems 306 is as follows: (a) a Windows operating system available from Microsoft Corporation; (b) a Netware operating system available from Novell, Inc.; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; or (f) an appliance-based operating system, such as that implemented in handheld computers or personal data assistants (PDAs) (e.g., PalmOS available from Palm Computing, Inc., and Windows CE available from Microsoft Corporation). The operating system 306 essentially controls the execution of other computer programs, such as the workforce planning system 300, and provides scheduling, input-output control, file and data management, memory management, and communication control and related services.

In some embodiments, the workforce planning system 300 is implemented using logic incorporated in programs such as a source program, executable program (object code), script, or any other entity comprising a set of instructions to be performed. When a source program, then the program needs to be translated via a compiler, assembler, interpreter, or the like, which may or may not be included within the memory 305, so as to operate properly in connection with the O/S 306. Furthermore, the workforce planning system 300 can be written as (a) an object oriented programming language, which has classes of data and methods, or (b) a procedure programming language, which has routines, subroutines, and/or functions, for example but not limited to, C, C++, Pascal, Basic, Fortran, Cobol, Perl, Java, and Ada.

The I/O devices 315 include input devices, for example but not limited to, a keyboard, mouse, scanner, microphone, etc. Furthermore, the I/O devices 315 also include output devices, for example but not limited to, a printer, display, etc. Finally, the I/O devices 315 further include devices that communicate both inputs and outputs, for instance but not limited to, a modulator/demodulator (modem; for accessing another device, system, or network), a radio frequency (RF) or other transceiver, a telephonic interface, a bridge, a router, etc.

Also shown in computing element 205 is a communication interface 320 that provides a digital communication link 102 between computing element 205 and various telecommunication devices such as a computer located in a call center, a computer located at an international location, and a communication switch such as communication switch 110 of FIGS. 1 and 2. Digital communication link 236 provides a link between communication interface 320 and a computer located in a call center, for example, PC 230 located in call center 130.

If the computing element 205 is a PC, workstation, or the like, the software in the memory 305 further includes a basic input output system (BIOS) (omitted for simplicity). The BIOS is a set of essential software routines that initialize and test hardware at startup, start the O/S 306, and support the transfer of data among the hardware devices. The BIOS is stored in ROM so that the BIOS can be executed when the computing element 205 is activated.

When the computing element 205 is in operation, the processor 310 is configured to execute software stored within the memory 305, to communicate data to and from the memory 305, and to generally control operations of the computing element 205 pursuant to the software. The workforce planning system 300 and the O/S 306, in whole or in part, but typically the latter, are read by the processor 310, perhaps buffered within the processor 310, and then executed.

When the workforce planning system 300 is implemented in software, as is shown in FIG. 3 hereafter, it should be noted that the workforce planning system 300 can be stored on any computer readable medium for use by or in connection with any computer related system or method. For example, the workforce planning system 300 can be detailed in a computer program or script that runs on a stand-alone server, a network server, or on one or more computers that are part of a network.

In the context of this document, a computer readable medium is an electronic, magnetic, optical, or other physical device or means that can contain or store a computer program for use by or in connection with a computer related system or method. The workforce planning system 300 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the workforce planning system 300 is implemented using hardware logic, the workforce planning system 300 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. The hardware can be housed in a stand-alone computer or in one or more computers of a network.

Drawing attention to workforce planning system 300 of FIG. 3, one functional block among many is shown as a database 308. Other functional blocks that operate to implement workforce planning system 300 have not been shown, and will be understood in the context of implementations as described in the following pages. It will also be understood, that while the workforce planning system 300 is illustrated as resident inside computing element 205, some or all of the software/hardware of this system 300 can be resident in other elements. As mentioned earlier, one example of such an implementation involves software located in one or more machines that are communicatively coupled to one another.

Database 308 comprises, in one exemplary embodiment, data that is formatted for processing by a Structured Query Language (SQL) program. In alternative embodiments, other programs such as, but not limited to, Microsoft Excel™, Microsoft Access™, and Oracle are used. Also, in other embodiments, unformatted data is stored in database 308. In one of several embodiments, database 308 contains data that is relevant to workforce planning system 300, for example, but not limited to, call-history statistics, work-history statistics, and predictive work statistics. Some of this data can be provided by a communication switch, such as communication switch 110 of FIGS. 1 and 2, via communication switch interface 320. In this context, communication switch interface 320 comprises a digital interface device that performs an electronic handshake with processing unit 112 located inside the communication switch 110, and downloads pertinent data via link 102. Alternatively, other means are employed to configure database 308. One such means includes a manual entry by an operator through I/O devices 315 that in this example, is a keyboard or a mouse. Manual entry means include entering data values into a spreadsheet for example, the spreadsheet being stored in database 308. The operator can obtain outputs such as printouts and on-screen displays of the spreadsheet, as well as other information pertinent to computing element 205 via suitable devices such as printers and displays of I/O devices 315.

Call-history statistics include, but are not limited to the number of calls forwarded from communication switch 110 to one or more call centers, telephone numbers, call duration, date information, calling period information, originating source (e.g., phone numbers of calling party), and call center identification as well. Call-history statistics can further include a breakdown of the nature of the calls, such as the number of directory assistance calls and/or the number of toll calls. Additionally, it also includes various work volumes related to these calls as recorded in the communication switch. Such call-history statistics will be explained further using other figures.

Work-history statistics include operator-related information, such as, but not limited to, headcount, composition (e.g. full-time, part-time, contract, student, trainee, bi-lingual etc.), staff attendance records, position seizures, revenue and deviations.

Predictive workforce statistics include but are not limited to, various types of forecasting reports, such as a headcount forecast report, a call-volume forecast report, an economic forecast report, and an equipment forecast report. While the predictive workforce statistics is derived from call-history statistics provided by a communication switch and/or work-history statistics provided by one or more call centers, in alternative embodiments, these estimates are drawn up by predictions made by WFMS staff that do not rely on past call history. In some instances, past calling history merely provides a guideline/basis but not a firm value towards a work load estimate. Futuristic factors such as growth of facilities, staff, and revenue may modify the predictive workforce statistics in a manner that is not necessarily consistent with past call history. Consequently, in certain embodiments, workforce planning system 300 accommodates such manual input where appropriate.

Several other pieces of data/information that are stored in database 308 will be identified or made obvious by further explanations that are done below with reference to other figures.

In alternative embodiments, computing element 205 communicates with various devices, such as personal computers, that are located in one or more call centers, to obtain data that is then stored in database 308. The communication between computing element 205 and the call centers takes place through communication switch 110, or through alternative means that do not involve communication switch 110. Such alternative means includes wireline/wireless communication devices such as microwave links, cell phones, and fiberoptic transceivers. Also included is written material, for example, documentation that is exchanged by regular mail between operators of the call centers and those of WFMS 100.

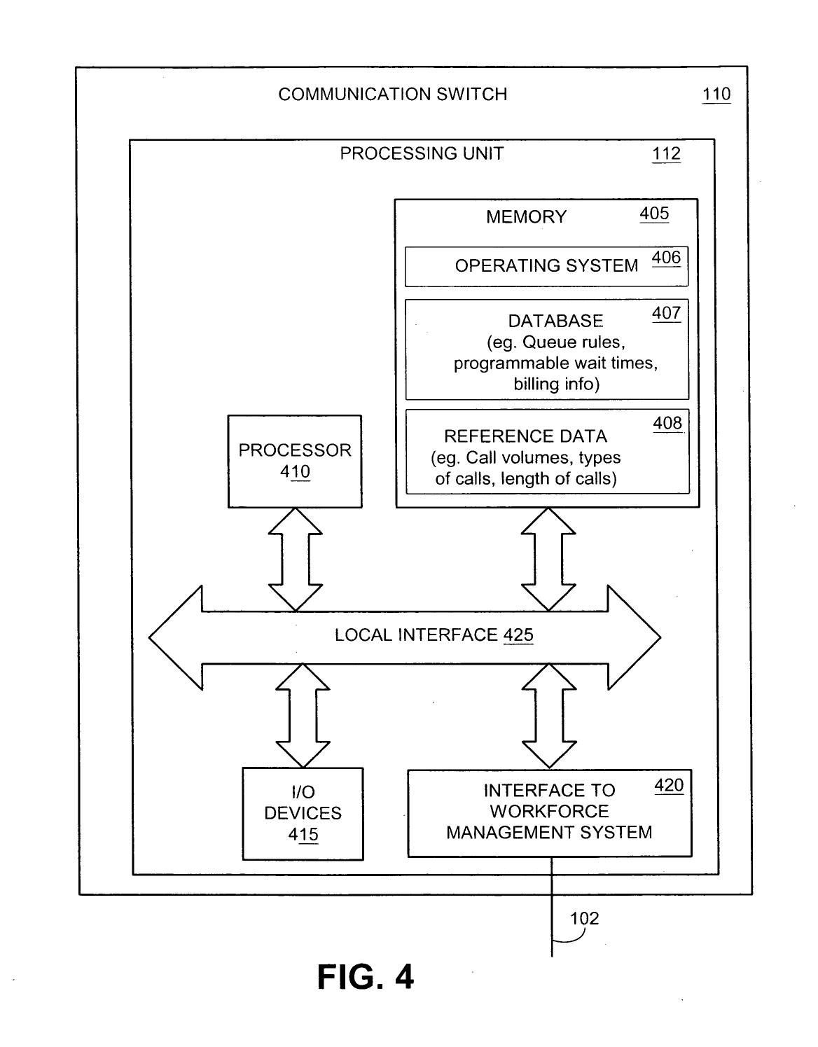

FIG. 4 is a block diagram illustrating various functional blocks incorporated inside processing unit 112 of communication switch 110. Generally, in terms of hardware architecture, as shown in FIG. 4, processing unit 112 includes a processor 410, memory 405, a WFMS interface 420, and one or more input and/or output (I/O) devices 415 (or peripherals) that are communicatively coupled via a local interface 425. It will be understood by persons of ordinary skill in the art, that the description of the hardware in FIG. 4 can be generally understood from the description provided for the equivalent hardware blocks shown in FIG. 3.

Processing unit 112 is generally configured to perform functions that are typically carried out by a controller circuit of a communication switch such as communication switch 110. Such functions typically encompass operations, administration, maintenance, and provisioning (OAMP) functions that are associated with switch 110. Additionally, processing unit 112 is configured to interface with WFMS 100 and to provide call-history statistics to WFMS 100. This is carried out via WFMS interface 420 that transmits digital data to WFMS 100 through link 102.

Memory 405 includes database 407 and reference database 408. While shown as two distinct database, it will be understood that this has been done merely for purposes of explanation, and several other database configurations can be used alternatively. These configurations include the use of databases located inside elements other than processing unit 112. Database 407 contains data that is used by communication switch 110, for example, queue rules, programmable wait times, billing data etc.

Database 408 comprises, in one exemplary embodiment, data that is formatted for processing by a Structured Query Language (SQL) program. In alternative embodiments, other programs such as, but not limited to, Microsoft Excel™, Microsoft Access™, and Oracle are used. Also, in other embodiments, unformatted data is stored in database 408. In one of several embodiments, database 408 contains data that is pertinent to workforce planning system 300. In the example where communication switch 110 is a POTS switch, this data comprises call-related data, such as, but not limited to, call volume over periods of time, call origination details, type of calls, date information, calling period information, average wait time, call-completed data such as call origination details, length of call, destination details, time data etc., call set-up data such as programmed wait times, call density, and average wait time.

While the data contained in databases 407 and/or 408 is in one embodiment transmitted electronically as an electronic spreadsheet, an e-mail, or by other electronic media to WFMS 100, in alternative embodiments, after transmission methods such as regular mail, telephone calls, faxes and other such media are employed to convey to WFMS 100, information from communication switch 110 that is relevant to workforce planning system 300.

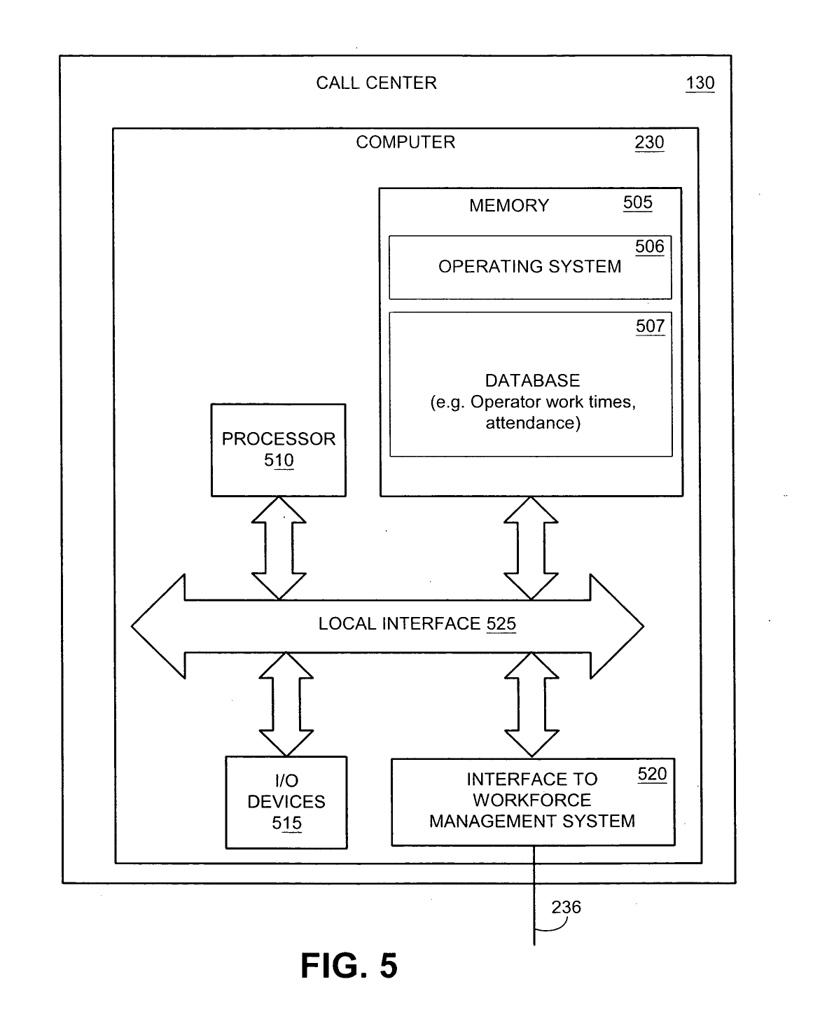

FIG. 5 is a block diagram illustrating various functional blocks incorporated inside computer 230 of call center 130. Generally, in terms of hardware architecture, as shown in FIG. 5, computer 230 includes a processor 510, memory 505, a WFMS interface 520, and one or more input and/or output (I/O) devices 515 (or peripherals) that are communicatively coupled via a local interface 525. It will be understood by persons of ordinary skill in the art, that the description of the hardware in FIG. 5 can be generally understood from the description provided for the equivalent hardware blocks shown in FIG. 4.

Computer 230 is a computing element that is a standalone device or a networked device located in call center 130, and is typically configured for use by administrative staff such as managers of the call center. Such a configuration generally encompasses operations, administration, and maintenance functions associated with managing the activities, such as payroll, vacation, and staffing, related to a number of call center operators. switch 110. In one example embodiment, computer 230 is configured to electronically and communicatively interface with WFMS 100 and provide various statistics to WFMS 100. This is carried out via WFMS interface 520 that transmits digital data to WFMS 100 through link 236.

Memory 505 includes one among several databases, a database 507 that contains data pertinent to workforce planning system 300. In one example of such data, database comprises actual work times (AWT), board hours, training hours, and attendance data related to operators of call center 130. Additionally, in alternative embodiments, database 507 contains call-related data, such as call-volume, dropped calls, abandoned calls, etc., where such call data is obtained from an automatic call distribution (ACD) unit located in the call center. This call data from the call center, together with call data obtained from the communication switch, also comprises call-history statistics that can be used by the workforce planning system 300.

While the data contained in database 507 is transmitted in one embodiment, electronically as an electronic spreadsheet, an e-mail, or by other electronic media to WFMS 100, in alternative embodiments transmission methods such as regular mail, telephone calls, faxes and other such media are employed to convey to WFMS 100, information from call center 130 that is relevant to workforce planning system 300.

Additionally, while FIG. 5 illustrates one exemplary embodiment, where data relevant to workforce planning system 300 is stored in database of a computer 230 in a call center 130, it will be understood that in alternative embodiments, such data is stored in electronic or non-electronic formats in other devices that are local or remote to WFMS 100. Such formats and devices include paper and other alternative storage/transmission media.

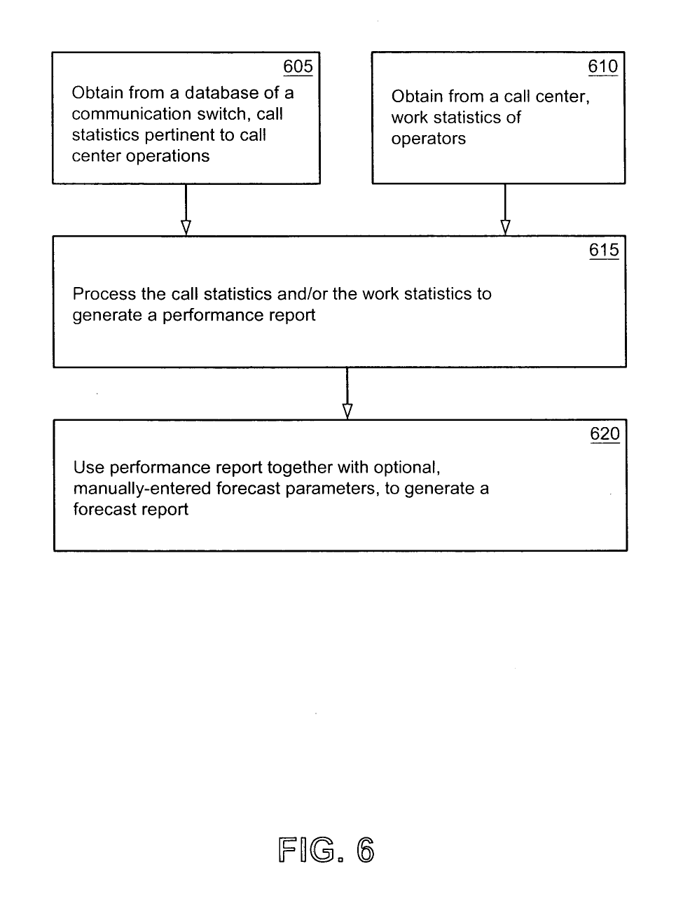

FIG. 6 is an exemplary flowchart describing one among many embodiments of a method for implementing the workforce planning system 300. In block 605, call-history statistics related to workforce planning system 300 are obtained from a database, such as database 408 in processing unit 112 of FIG. 4. In one exemplary embodiment, this step is implemented by electronically transferring, via link 102, such data from processing unit 112 to workforce planning system 300 in computing element 205 of the workforce management system 100. In a second exemplary embodiment, the call-history statistics are entered into the workforce planning system 300 via alternative mechanisms, such as e-mail, phone-calls, fax, and keyboard operations.

In block 610, work-history statistics related to workforce planning system 300 are obtained from a call center database, such as database 507 in computer 230 of FIG. 5. In one exemplary embodiment, this step is implemented by electronically transferring, via link 236, such data from computer 230 to workforce planning system 300 in computing element 205 of the workforce management system 100. In a second exemplary embodiment, the work-history statistics are entered into the workforce planning system 300 via alternative mechanisms, such as e-mail, phone-calls, fax, and keyboard operations.

In block 615, the call-history statistics and/or the work-history statistics are processed to generate a past performance report. One example of such a process involves determining a difference between a call volume, which is a call-history statistic, and an actual work time (AWT) value, which is a work-history statistic, to generate an actual work volume. In a second example, an abandonment rate (AR) is calculated by solely utilizing call-history statistics. In a third example, an adjusted estimate of call volume is calculated by utilizing work-history statistics together with certain estimated parameters such as economic erosion. These are three examples among numerous operations that will be apparent to persons of ordinary skill in the art.

In block 620, the past performance report generated in step 615 is used to generate a forecast report that comprises a workforce planning report, containing for example, predictive workforce statistics. Such statistics includes, in one or more embodiments, a breakdown of the number of employees required for various periods of time in the future, for example, on a monthly basis; and the qualifications of the employees, for example a desirable level of experience and language skills. The report further includes a recommendation defining employment characteristics, such as full-time, part-time, student trainee, etc., as well as predicted attrition rates of employment, wherein some employees quit and other employees are hired.

A non-exhaustive list of examples related to topics addressed by a workforce planning report, is provided below:

Forecasting the impact on call center operations (e.g. an overall AWT), when using a certain number of inexperienced operators such as students, during a certain month in the future.

Forecasting the impact on overall AWT during the month following the month referred above, when the operators having gained some work experience.

Forecasting the financial impact of employing the students during these months. If a certain level of occupancy is desired in a future month, forecasting an employee profile and quantity information of employees to be hired.

Referring to the quantity information above, if employee hiring is required, allocating time over a period of several weeks, for training of the new employees, while also allocating appropriate teaching time for supervisory staff to carry out the training.

Forecasting the attendance trends of various types of employees.

Using a comparison between weekend and weekday statistics to forecast future patterns.

Comparing the level of overhead expenses to the overall budget, and suggesting suitable changes to future overhead expenses.

If these changes include cutting staff, estimating the impact on call center performance, such as AWT.

Estimating the effect upon call center operations, of factors such as war, national economy, and competition from other providers.

The workforce planning report includes, in certain embodiments, an analysis of past performance, wherein such analysis is carried out on an average business day basis, thereby allowing a workforce planning staff member to study the effectiveness of earlier forecasts, and also to generate appropriate forecasts for future periods of time. The generation of such forecasts is implemented in several different ways as described below.

In a first example, the workforce planning system is used to process past performance statistics to inherently generate future forecast statistics. Such processing of past performance statistics incorporates several statistical techniques such as correlation, comparison, averaging, trending, and other number manipulating techniques to obtain forecast values. Also, such processing takes into consideration aberrations and anomalies in the data, and may further, be performed using algorithmic techniques, including neural processing. One example among many of processing past performance statistics to generate future forecast statistics, involves the use of call statistics related to student operators, including AWT information and attendance information. While the AWT information referred to here provides a work quality forecast statistic, the attendance information provides a trend that can be used to set future student hiring requirements. It can be appreciated that such attendance information often incorporates strong seasonal factors that are related to college class sessions, and consequently, the workforce planning system can predict that this type of student employment will not be available during certain months of the year.

While in the first example above, the workforce planning system is used to process past performance statistics to inherently generate future forecast statistics, in a second example, future forecast statistics are generated by a manual process wherein a workforce management staff member analyzes certain past performance statistics and manually enters data parameters into the system. When this data is entered, the workforce planning system operates to provide feedback to the staff member indicating the impact of this entry upon future forecast statistics. One example among many, of such a manual-feedback process, involves a staff member analyzing two years of student attendance data and determining that a student will not be available for employment during an ensuing month. When this data is entered into the system, the workforce planning system processes the input and determines that this is an erroneous entry, because past performance statistics indicate that this student, or a similar student was indeed available because the school year did not begin until three months later. This determination made by the system in this example is based on five previous years of data, whereas the staff member had examined only two years of data during which the student had been unavailable for employment due to other reasons.

In a third example, future forecast statistics are generated by a manual process wherein a workforce management staff member enters certain statistics that have been pre-determined. In this example, such pre-determined statistics are based upon agreements with clients, and consequently, be non-negotiable. Under this scenario, the workforce planning system merely processes the input data and provides details of future impacts as a result of this input. The staff member can then accept these results, or can alternatively modify them within allowable constraints. One example, of such a modification comprises changing the system-recommended future headcount of four full time employees to two full time employees coupled with three students.

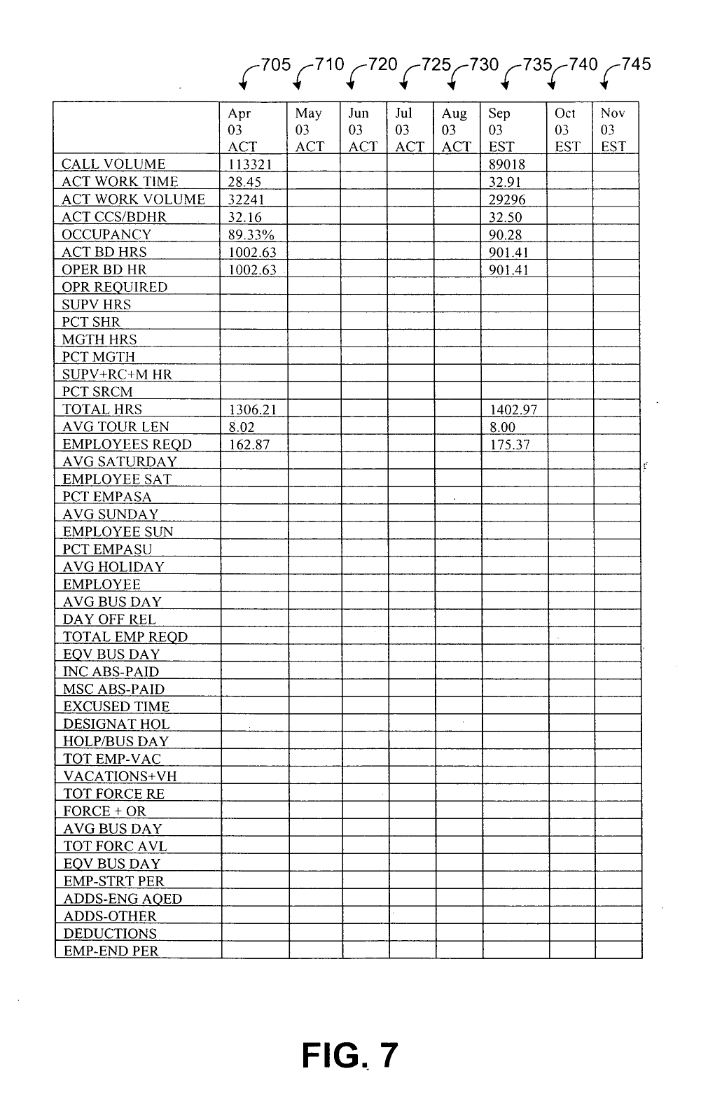

FIG. 7 is one embodiment, among many embodiments, of a workforce planning report. The report comprises a list of parameters entered into multiple rows. Data on a periodic basis (monthly, in this example), corresponding to these parameters, are presented in multiple columns. In this example, the report includes past performance as well as future forecast statistics. Columns 705, 710, 720, 725, and 730 are past performance statistics (actuals), while columns 735, 740, and 745 are future forecasts (estimates).

The list of row parameters includes some that are inputs while others are the result of processing/calculation in the workforce planning system. For example, the call volume entry and the actual work time entries are inputs that can be directly provided by the communication switch database or alternatively input by a WFMS staff; while the actual work volume entry is an output generated by the system. Similarly, the occupancy entry is also an input. Not all entries of the report are shown in FIG. 7.

To illustrate one operation of this report, the April 2003 (actual) entries (only relevant entries shown) are past performance values and are used by the staff to evaluate past predictions. These numbers can be used to generate (automatically and/or manually) some of the input entries related to columns 735, 740, and 745 for forecast purposes. Therefore, for example, if the predicted inputs such as call volume, actual work time, and occupancy, among others, are entered as shown in column 735, the corresponding output values such as “employees required” will be generated by the workforce planning system.

It should be emphasized that the above-described embodiments of the present disclosure are merely possible examples of implementations and are set forth merely for providing a clear understanding of the principles of the disclosure. Many variations and modifications may be made to the above-described embodiment(s) of the disclosure without departing substantially from the spirit and principles of the disclosure. For example, it will be understood by persons of ordinary skill in the art, that several implementations upon several switches other than POTS switches can be carried out to implement this workforce planning system. All such modifications and variations are intended to be included herein within the scope of this disclosure and the present disclosure and protected by the following claims.

1. A workforce planning system, the system comprising:
logic configured to obtain from a communication switch, a first call-history statistic of a first period of time;
logic configured to obtain from a call center, a first work-history statistic of the first period of time;
logic configured to process at least one of the first call-history statistic and the first work-history statistic; and
logic configured to generate a performance report comprising a first past performance statistic.

2. The system of claim 1, wherein the first call-history statistic comprises a total number of calls routed by the communication switch to the call center over the first period of time.

3. The system of claim 1, wherein the first call-history statistic comprises a total number of a first type of calls routed by the communication switch to the call center over the first period of time.

4. The system of claim 1, wherein the first work-history statistic comprises an actual work time of the call center over the first period of time, and the first past performance statistic is a first workforce occupancy.

5. The system of claim 1, further comprising:
logic configured to provide a first work-planning input;
logic configured to process the first work-planning input together with the first report; and
logic configured to generate a forecast report comprising a first predictive workforce statistic.

6. The system of claim 5, wherein the first work-planning input comprises at least one of a first number of operators over a first forecast period, a change in call volume over the first forecast period, an attendance statistic of the first number of operators over the first forecast period, and a performance statistic of the first number of operators over the first forecast period.

7. The system of claim 5, wherein the first predictive workforce statistic comprises at least one of an actual work time of a first number of operators over a first forecast period, an occupancy of the first number of operators over the first forecast period, and a forecast of a number of operators required for call handling during the first forecast period.

8. The system of claim 5, wherein the performance report provides the first work-planning input.

9. The system of claim 5, wherein the first work-planning input comprises a first number of operators during a first forecast period and a second number of operators during a second forecast period.

10. The system of claim 9, wherein the performance report provides the work-planning input.

11. The system of claim 5, wherein the first work-planning input comprises a first number of operators having a first level of performance during a first forecast period and a second level of performance during a second forecast period.

12. The system of claim 11, wherein the performance report provides the work-planning input.

13. A method of workforce planning in a workforce management system, the method comprising:
obtaining from a communication switch, a first call-history statistic of a first period of time;
obtaining from a call center, a first work-history statistic of the first period of time;
processing at least one of the first call-history statistic and the first work-history statistic; and
generating a performance report comprising a first past performance statistic.

14. The method of claim 13, wherein the first call-history statistic comprises a total number of calls routed by the communication switch to the call center over the first period of time.

15. The method of claim 13, wherein the first call-history statistic comprises a total number of a first type of calls routed by the communication switch to the call center over the first period of time.

16. The method of claim 13, wherein the first work-history statistic comprises an actual work time of the call center over the first period of time, and the first past performance statistic is a first workforce occupancy.

17. The method of claim 13, further comprising:
providing a first work-planning input;
processing the first work-planning input together with the first report; and generating a forecast report comprising a first predictive workforce statistic.

18. The method of claim 17, wherein the first work-planning input comprises at least one of a first number of operators over a first forecast period, a change in call volume over the first forecast period, an attendance statistic of the first number of operators over the first forecast period, and a performance statistic of the first number of operators over the first forecast period.

19. The method of claim 17, wherein the first predictive workforce statistic comprises at least one of an actual work time of a first number of operators over a first forecast period, an occupancy of the first number of operators over the first forecast period, and a forecast of a number of operators required for call handling during the first forecast period.

20. The method of claim 17, wherein the performance report provides the first work-planning input.

21. The method of claim 17, wherein the first work-planning input comprises a first number of operators during a first forecast period and a second number of operators during a second forecast period.

22. The method of claim 21, wherein the performance report provides the work-planning input.

23. The method of claim 17, wherein the first work-planning input comprises a first number of operators having a first level of performance during a first forecast period and a second level of performance during a second forecast period.

24. The method of claim 23, wherein the performance report provides the work-planning input.

25. A workforce planning system stored on a computer-readable medium, the system comprising:
computer-readable code that obtains from a communication switch, a first call-history statistic of a first period of time;
computer-readable code that obtains from a call center, a first work-history statistic of the first period of time;
computer-readable code that processes at least one of the first call-history statistic and the first work-history statistic; and
computer-readable code that generates a performance report comprising a first past performance statistic.

26. The system of claim 25, wherein the first call-history statistic comprises a total number of calls routed by the communication switch to the call center over the first period of time.

27. The system of claim 25, wherein the first call-history statistic comprises a total number of a first type of calls routed by the communication switch to the call center over the first period of time.

28. The system of claim 25, wherein the first work-history statistic comprises an actual work time of the call center over the first period of time, and the first past performance statistic is a first workforce occupancy.

29. The system of claim 25, further comprising:
computer-readable code that provides a first work-planning input;
computer-readable code that processes the first work-planning input together with the first report; and
computer-readable code that generates a forecast report comprising a first predictive workforce statistic.

30. The system of claim 29, wherein the first work-planning input comprises at least one of a first number of operators over a first forecast period, a change in call volume over the first forecast period, an attendance statistic of the first number of operators over the first forecast period, and a performance statistic of the first number of operators over the first forecast period.

31. The system of claim 29, wherein the first predictive workforce statistic comprises at least one of an actual work time of a first number of operators over a first forecast period, an occupancy of the first number of operators over the first forecast period, and a forecast of a number of operators required for call handling during the first forecast period.

32. The system of claim 29, wherein the performance report provides the first work-planning input.

33. The system of claim 29, wherein the first work-planning input comprises a first number of operators during a first forecast period and a second number of operators during a second forecast period.

34. The system of claim 33, wherein the performance report provides the work-planning input.

35. The system of claim 29, wherein the first work-planning input comprises a first number of operators having a first level of performance during a first forecast period and a second level of performance during a second forecast period.

36. The system of claim 35, wherein the performance report provides the work-planning input.
